(19) United States
(12) Patent Application Publication
(10) Pub. No.: US 2013/0016016 A1
(43) Pub. Date: Jan. 17, 2013

(54) ANTENNA STRUCTURE FOR WEARABLE ELECTRONIC DEVICE AND WEARABLE WIRELESS ELECTRONIC DEVICE

(71) Applicants: Chia-Hong Lin, Hsinchu (TW); Jui-Hsiang Chou, Hsinchu (TW); I-Shan Chen, Hsinchu (TW)

(72) Inventors: Chia-Hong Lin, Hsinchu (TW); Jui-Hsiang Chou, Hsinchu (TW); I-Shan Chen, Hsinchu (TW)

(21) Appl. No.: 13/241,242

(22) Filed: Sep. 23, 2011

(30) Foreign Application Priority Data
Jul. 15, 2011 (TW) 100125088

(51) Int. Cl. H01Q 1/24; H01Q 1/12

(52) U.S. Cl. 343/702; 343/718

(57) ABSTRACT

An antenna structure for wearable electronic device has a device casing, an antenna ground structure joined with the device casing, a carrier connected to the device casing, and an antenna radiation structure joined with the carrier. Thereby, the antenna structure can be integrated into the original structure of a wearable device so that the volume of the wearable device can be reduced, which solves the difficulty in reducing the volume of a wireless communication device with a requirement of an antenna disposition in the prior art. In addition, a wearable wireless electronic device has the antenna structure so as to have the advantage of smaller volume relative to a wearable wireless electronic device in the prior art.

### BACKGROUND OF THE INVENTION

1. Field of the Invention

The invention relates to an antenna structure and an electronic device, and especially relates to an antenna structure joined in a wearable electronic device and to a wearable wireless electronic device having the antenna structure.

2. Description of the Prior Art

As wireless communication technology develops, most current portable electronic devices have wireless communication function. The wireless communication needs a physical antenna to be the medium for transmitting or receiving signals. Moreover, based on antenna operation principle, the antenna needs a certain isolated space for operation. So the volume of the whole electronic device can be hardly reduced, even though other components thereof can be reduced in volume. In other words, the current antenna structure is not suitable for small-volume communication electronic devices. Furthermore, the isolated space for operation is usually stationary, so the current antenna structure is disposed statically and not easily integrated with other components structurally. Especially when the volume of the electronic device such as an electronic device worn on a wrist is small, the integration problem of the aforementioned structure becomes worse. In general, for keeping a good antenna performance, the required space for the disposition of the antenna makes the volume of the whole device large; on the contrary, for keeping the device with small and exquisite appearance, the antenna performance is lost somewhat. Therefore, the design for the current small wireless communication electronic device gets into the dilemma of the antenna performance and the device appearance and cannot satisfy both.

### SUMMARY OF THE INVENTION

An objective of the invention is to provide an antenna structure for wearable electronic device, which is capable of being joined with the structure of a wearable electronic device so as to satisfy the requirement of both the antenna performance and the whole device appearance.

The antenna structure of the invention includes a device casing, an antenna ground structure, a carrier, and an antenna radiation structure. The antenna ground structure is joined with the device casing. The carrier is connected to the device casing. The antenna radiation structure is joined with the carrier. Thereby, the antenna structure can be integrated into the original structure of the wearable electronic device so that the whole appearance of the wearable electronic device can be maintained and the wearable electronic device can have the wireless communication function. The antenna structure of the invention can satisfy the requirement of both the antenna performance and the device appearance.

Another objective of the invention is to provide a wearable wireless electronic device having the antenna structure of the invention, so the requirement of the antenna performance and the device appearance can be satisfied, which solves the problem that the small-volume electronic device gets into the dilemma of satisfying the antenna performance or the device appearance in the prior art.

The wearable wireless electronic device of the invention includes a device casing, an antenna ground structure, a carrier, an antenna radiation structure, and a processing module. The antenna ground structure is joined with the device casing. The carrier is connected to the device casing. The antenna radiation structure is joined with the carrier. The processing module is disposed in the device casing and electrically connected to the antenna ground structure and the antenna radiation structure so as to perform wireless communication through the antenna ground structure and the antenna radiation structure. Thereby, the wearable wireless electronic device uses its original structure to dispose the antenna, so the wearable wireless electronic device can have good wireless communication function with the structure unchanged or less modification.

In sum, the invention integrates the antenna structure into the original structure of the device so as to satisfy the requirement of the antenna performance and the device appearance, which solves the problem that the wearable wireless communication electronic device gets into the dilemma of satisfying the antenna performance or the device appearance in the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating wearable wireless electronic device 1 of a preferred embodiment according to the present invention.

FIG. 2 is a schematic diagram illustrating the wearable wireless electronic device in FIG. 1 spread and partially cut.

FIG. 3 is a side view of the wearable wireless electronic device in FIG. 2 partially cut.

FIG. 4 is a side view of a wearable wireless electronic device of another preferred embodiment according to the invention.

FIG. 5 is a schematic diagram illustrating wearable wireless electronic device of another preferred embodiment according to the present invention.

FIG. 6 is a schematic diagram illustrating wearable wireless electronic device of another preferred embodiment according to the present invention.

### DETAILED DESCRIPTION

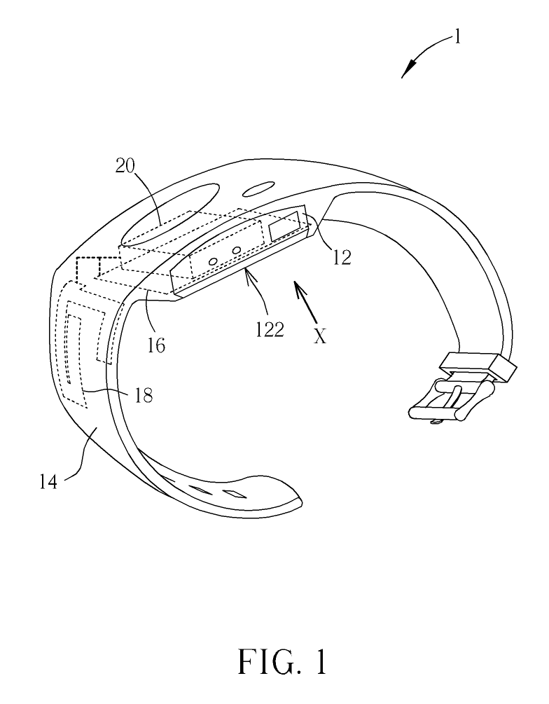

Please refer to FIG. 1. FIG. 1 is a schematic diagram illustrating wearable wireless electronic device 1 of a preferred embodiment according to the present invention. In the embodiment, the wearable wireless electronic device 1 is a wrist watch. The wearable wireless electronic device 1 includes a device casing 12, a belt carrier 14, an antenna ground structure 16, an antenna radiation structure 18, and a processing module 20. The antenna ground structure 16, the antenna radiation structure 18, and the processing module 20 are shown by dashed lines in FIG. 1. The belt carrier 14 is connected to the device casing 12. The antenna ground structure 16 is joined with the device casing 12. The antenna radiation structure 18 is joined with the belt carrier 14. The processing module 20 is disposed in the device casing 12 and electrically connected to the antenna ground structure 16 and the antenna radiation structure 18 (shown by bold dashed lines in FIG. 1) so as to perform wireless communication through the antenna ground structure 16 and the antenna radiation structure 18.

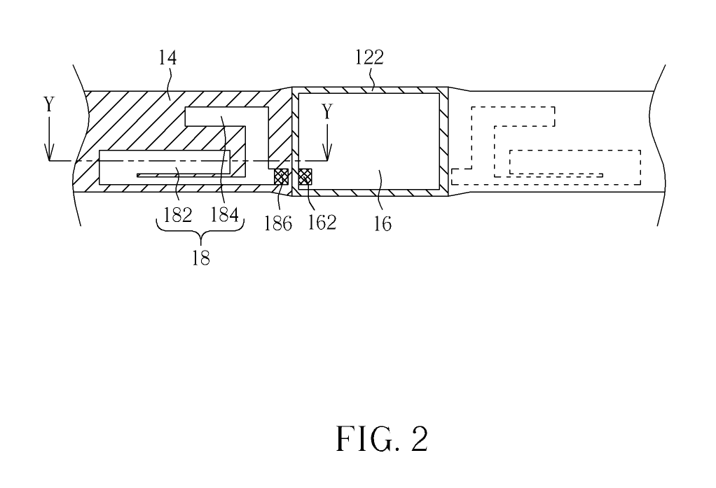

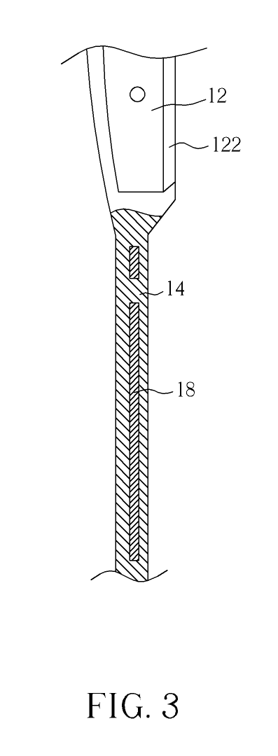

Please also refer to FIG. 2 and FIG. 3. FIG. 2 is a schematic diagram illustrating the wearable wireless electronic device 1 spread and partially cut; its view point is shown as the arrow X in FIG. 1. FIG. 3 is a side view of the wearable wireless electronic device 1 partially cut; its cutting position is shown as the line Y-Y in FIG. 2. In the embodiment, the device casing 12 includes a back cover 122. The antenna ground structure 16 is joined with the back cover 122. In practice, if the back cover 122 is made of metal, the antenna ground structure 16 is integrated into the back cover 122 directly; that is, the antenna ground structure 16 is formed by the back cover 122. Furthermore, if the whole device casing 12 is made of metal, the whole device casing 12 can be regarded as the ground for the antenna structure.

The belt carrier 14 is a wrist strap, so that the wearable wireless electronic device 1 can be worn on a wrist of a user. In the embodiment, the belt carrier 14 is a watch strap, which in structure is a combination of two straps capable of being engaged with each other. The antenna radiation structure 18 includes two radiation members 182 and 184, which are a quarter-wave slot metal radiation member and a quarter-wave metal radiation member respectively and provide a low resonance frequency band covering CDMA BC0-CELL 824˜894 MHz and a high resonance frequency band covering two systems of CDMA BC1-PCS 1850˜1990 MHz and GPS 1575.42 MHz±1.024 MHz respectively. The radiation members 182 and 184 use the same feed-in port 186. If a coaxial cable is used as the transmission line, its outer conductor is soldered to the ground port 162 of the antenna ground structure 16. Furthermore, in the embodiment, the antenna radiation structure 18 is embedded in the belt carrier 14. For example, a copper plate is cut to fit a required size then to be processed in an insert molding process for forming the belt carrier 14. The material used in the insert molding process can be general engineering plastic, rubber, silicone, or other high molecular polymer, but the invention is not limited to it. For another example, the radiation members 182 and 184 are formed on a flexible carrier first then to be processed together with the flexible carrier in the abovementioned insert molding process; alternatively, the belt carrier 14 can be formed by sticking two straps with the antenna radiation structure 18 therebetween. It can obtain a hiding effect to dispose the antenna radiation structure 18 in an insertion way, which is conducive to the appearance design for the wearable wireless electronic device 1; however, the invention is not limited to it. In practice, the combination of the antenna radiation structure 18 and the device casing 12 is not limited to the insertion way. For example, the antenna radiation structure 18 is only attached or inlaid onto the belt carrier 14. In this case, the shape of the antenna radiation structure 18 can be designed into a part of the appearance of the wearable wireless electronic device 1.

It is added that, in the embodiment, the antenna radiation structure 18 includes the only two radiation members 182 and 184 to provide the two resonance frequency bands, but the invention is not limited to it. In practice, the antenna radiation structure 18 can be designed in size to provide more resonance frequency bands so as to fit the communication requirement of the wearable wireless electronic device 1; therein, the material of the belt carrier 14 is also a consideration. Furthermore, in the embodiment, the radiation members 182 and 184 are disposed at the same side of the antenna ground structure 16 and extend parallel to each other; however, the invention is not limited to it. For example, the radiation members 182 and 184 can be disposed at two opposite sides of the antenna ground structure 16 respectively; even in practice, there are several radiation members at each of the two sides of the antenna ground structure 16 for enhancing the antenna performance. Therein, the radiation members at the other side are shown by dashed lines in FIG. 2.

Therefore, the wearable wireless electronic device 1 is basically identical to a common watch but has wireless communication function. Moreover, the antenna structure of the wearable wireless electronic device 1 uses the structure outside the device casing 12, so the antenna structure is not limited by the volume of the device casing 12 and has a larger radiation surface so as to have a good antenna performance. In sum, the wearable wireless electronic device 1 satisfies the antenna performance and the device appearance, which solves the problem that the wearable wireless communication electronic device gets into the dilemma of satisfying the antenna performance or the device appearance in the prior art.

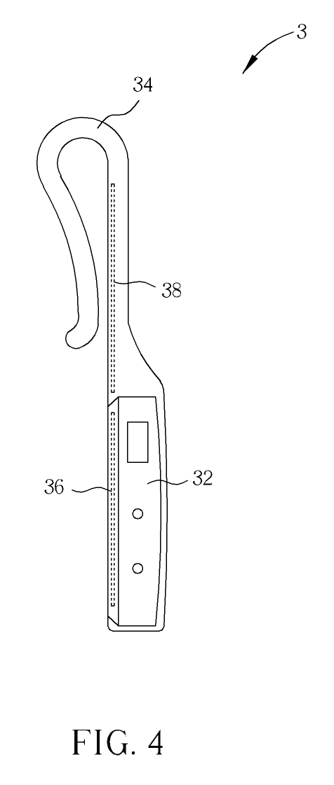

Please refer to FIG. 4. FIG. 4 is a side view of a wearable wireless electronic device 3 of another preferred embodiment according to the invention. In the embodiment, the wearable wireless electronic device 3 is a waist watch, put on the waist of a user, for example on a leather belt or the waistline of pants. The wearable wireless electronic device 3 is substantially similar to the wearable wireless electronic device 1 in structure. The main difference is that a belt carrier 34 of the wearable wireless electronic device 3 is a waist clip. Only one side of a device casing 32 is connected to the belt carrier 34. An antenna ground structure 36 (shown by dashed lines in FIG. 4) is joined with the device casing 32. An antenna radiation structure 38 (shown by dashed lines in FIG. 4) is joined with the belt carrier 34. A processing module (not shown in FIG. 4) is disposed in the device casing 32. For other descriptions about the components of the wearable wireless electronic device 3, please refer to the relative descriptions of the wearable wireless electronic device 1; they are no longer described herein. Similarly, the wearable wireless electronic device 3 is basically identical to a common waist watch, so the wearable wireless electronic device 3 also can satisfy the antenna performance and the device appearance, which solves the dilemma faced by the wearable wireless communication electronic device in the prior art.

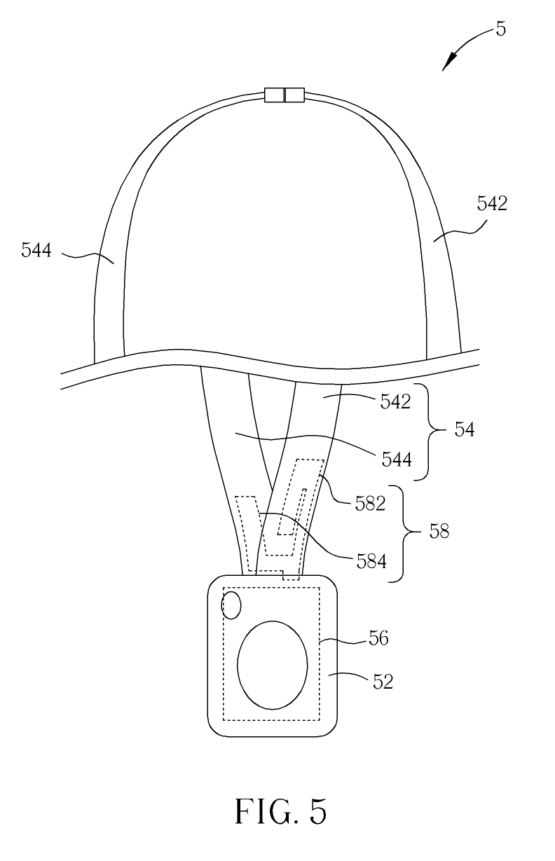

Please refer to FIG. 5. FIG. 5 is a schematic diagram illustrating wearable wireless electronic device 5 of another preferred embodiment according to the present invention. In the embodiment, the wearable wireless electronic device 5 is a neck watch, worn on the neck of a user. The wearable wireless electronic device 5 is substantially similar to the wearable wireless electronic device 1 in structure. The main difference is that a belt carrier 54 of the wearable wireless electronic device 5 is a neck strap including two straps 542 and 544 which are connected to a device casing 52 and also connected to each other to form a ringed belt, i.e. the neck strap. The user can wear the neck strap on his neck. Furthermore, two radiation members 582 and 584 (shown by dashed lines in FIG. 5) of an antenna radiation structure 58 are joined with the straps 542 and 544 respectively, which fully utilizes the structures of the straps 542 and 544. An antenna ground structure 56 (shown by dashed lines in FIG. 5) is joined with the device casing 52. In the embodiment, the straps 542 and 544 may suffer slight bending or twisting in use. However, the straps 542 and 544 are made of metal so they have the resilience capability in a certain extent such that the antenna radiation structure 58 can keep working normally and can keep its coplanarity substantially. Furthermore, a processing module (not shown in FIG. 5) is disposed in the device casing 52. For other descriptions about the components of the wearable wireless electronic device 5, please refer to the relative descriptions of the wearable wireless electronic device 1; they are no longer described herein. Similarly, the wearable wireless electronic device 5 is basically identical to a common neck watch, so the wearable wireless electronic device 5 also can satisfy the antenna performance and the device appearance, which solves the dilemma faced by the wearable wireless communication electronic device in the prior art.

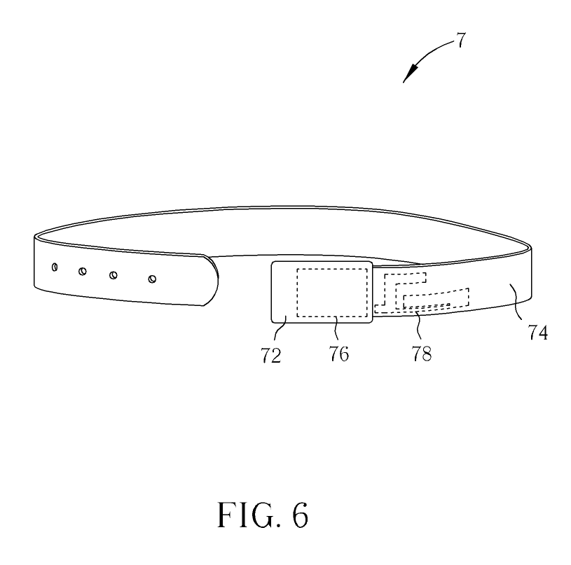

In the above embodiments, the wearable wireless electronic devices 1, 3, and 5 respectively have the antenna structure of the invention so they have the wireless communication function. They can perform functions different to those of common watches so as to be multi-function watches. For example, they can combine with a global positioning system to be positioning devices or combine with a voice function to be cell phones. Furthermore, in the above embodiments, the antenna structure of the invention is joined with an electronic watch, but the invention is not limited to it. For example, the wearable electronic device which the antenna structure of the invention is joined with can be a device of monitoring signs of life for sensing signs of life of a user, such as heartbeats, pulses and so on; the wearable electronic device can also be a wireless calling device for a user to send mayday signals. Please refer to FIG. 6. FIG. 6 is a schematic diagram illustrating wearable wireless electronic device 7 of another preferred embodiment according to the present invention. In the embodiment, the wearable wireless electronic device 7 is an electronic device combined with a leather belt, so a user can use the wearable wireless electronic device 7 as a leather belt. The electronic device can be a device of monitoring signs of life, a wireless calling device, or other electronic device with wireless communication function. The wearable wireless electronic device 7 is substantially similar to the wearable wireless electronic device 1 in structure. The main difference is that a belt carrier 74 of the wearable wireless electronic device 7 is a waist belt and a device casing 72 is a belt head connected to the belt carrier 74. An antenna ground structure 76 (shown by dashed lines in FIG. 6) is joined with the device casing 72. An antenna radiation structure 78 (shown by dashed lines in FIG. 6) is joined with the belt carrier 74. A processing module (not shown in FIG. 6) is disposed in the device casing 72. Because having a larger area, the waist belt can accommodate an antenna structure with more complex structure which is conducive to obtaining a better antenna performance. For other descriptions about the components of the wearable wireless electronic device 7, please refer to the relative descriptions of the wearable wireless electronic device 1; they are no longer described herein. Similarly, the wearable wireless electronic device 7 is basically identical to a common belt head, so the wearable wireless electronic device 7 also can satisfy the antenna performance and the device appearance, which solves the dilemma faced by the wearable wireless communication electronic device in the prior art.

As discussed above, the antenna structure of the invention is integrated in the structural of a wearable electronic device, so as to obtain a hiding effect. Besides, the antenna structure is disposed outside the device casing of the wearable electronic device so as to provide good antenna radiation efficiency. Furthermore, the wearable wireless electronic device of the invention has the antenna structure of the invention so as to satisfy the antenna performance and the device appearance. Therefore, the antenna structure and the wearable wireless electronic device of the invention can solves the problem that the wearable wireless communication electronic device gets into the dilemma of satisfying the antenna performance or the device appearance in the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna structure for wearable electronic device, comprising:
a device casing;
an antenna ground structure, joined with the device casing;
a carrier, connected to the device casing; and
an antenna radiation structure, joined with the carrier.

2. The antenna structure of claim 1, wherein the carrier is a neck strap, a wrist strap, a waist clip, or a belt of an electronic device.

3. The antenna structure of claim 2, wherein the electronic device is a multi-function watch, a device of monitoring signs of life, or a wireless calling device.

4. The antenna structure of claim 1, wherein the device casing comprises a back cover of an electronic device for forming the antenna ground structure.

5. The antenna structure of claim 1, wherein the antenna radiation structure comprises two radiation members.

6. The antenna structure of claim 5, wherein one of the two radiation members is a quarter-wave slot metal radiation member.

7. The antenna structure of claim 5, wherein the carrier comprises two straps connected to form a ringed belt, and the two radiation members are joined with the two straps respectively.

8. The antenna structure of claim 5, wherein the two radiation members are disposed at a side of the antenna ground structure.

9. The antenna structure of claim 1, wherein the antenna radiation structure is embedded in the carrier.

10. The antenna structure of claim 9, wherein the carrier is made of engineering plastic, rubber, or silicone.

11. The antenna structure of claim 1, wherein the antenna radiation structure has at least two resonance frequency bands.

12. A wearable wireless electronic device, comprising:
a device casing;
an antenna ground structure, joined with the device casing;
a carrier, connected to the device casing;
an antenna radiation structure, joined with the carrier; and
a processing module, disposed in the device casing and electrically connected to the antenna ground structure and the antenna radiation structure so as to perform wireless communication through the antenna ground structure and the antenna radiation structure.

13. The wearable wireless electronic device of claim 12, wherein the carrier is a neck strap, a wrist strap, a waist clip, or a belt.

14. The wearable wireless electronic device of claim 12, wherein the device casing comprises a back cover for forming the antenna ground structure.

15. The wearable wireless electronic device of claim 12, wherein the antenna radiation structure comprises two radiation members.

16. The wearable wireless electronic device of claim 15, wherein one of the two radiation members is a quarter-wave slot metal radiation member.

17. The wearable wireless electronic device of claim 15, wherein the carrier comprises two straps connected to form a ringed belt, and the two radiation members are joined with the two straps respectively.

18. The wearable wireless electronic device of claim 15, wherein the two radiation members are disposed at a side of the antenna ground structure.

19. The wearable wireless electronic device of claim 12, wherein the antenna radiation structure is embedded in the carrier.

20. The wearable wireless electronic device of claim 19, wherein the carrier is made of engineering plastic, rubber, or silicone.

21. The wearable wireless electronic device of claim 12, wherein the antenna radiation structure has at least two resonance frequency bands.
